(19) United States
(12) Patent Application Publication
(10) Pub. No.: US 2008/0077449 A1
(43) Pub. Date: Mar. 27, 2008

(54) Providing and Financing Post-Employment Health Care Benefits

(75) Inventors: Charles Klippel, Avon, CT (US); Rhonda L. Lessard, South Windsor, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AETNA INC., Hartford, CT (US)

(21) Appl. No.: 11/534,940

(22) Filed: Sep. 25, 2006

(51) Int. Cl. G06Q 40/00

(52) U.S. Cl. 705/4

(57) ABSTRACT

A health account retirement plan (“HARP”) is described that can be used by a retiree for health care related expenses. Under the HARP, an employer pays an annual premium to an insurance company such as a health insurance company. In exchange, the insurer funds and administers health accounts for eligible employees at retirement. Employees become eligible for these benefits according to a pre-determined eligibility schedule comparable to a vesting schedule for pension benefit. Once eligible, if an employee retires, he can use the account for health care related expenses including both premiums and health claims.

### FIELD OF THE INVENTION

This invention relates generally to the field of employee benefit insurance and more specifically to the area of retirement health care benefits.

### BACKGROUND OF THE INVENTION

In a world of increasing awareness of healthcare issues and greater demand for health services, availability of affordable health insurance is a driving factor in decisions affecting a wide spectrum of issues—from quality of life, to personal finances and family planning. Although the basic principles of health insurance may not have changed, increasing costs of healthcare have created opportunities for many variations and nuances beyond the basic principles in order to more adequately serve the needs of health insurance consumers. These variations include different types of plans, such as POS, PPO, and HMO, increasingly coupled with health accounts such as flexible spending arrangements, health reimbursement arrangements, and health savings accounts.

The need for new approaches to retirement health benefits is particularly acute. More and more Americans of the baby-boom generation are reaching retirement, retirees are living longer and more active lives, and they are consumer more health care services. As a result the costs of post-employment health care rising dramatically. For many retirees, it is now estimated that their expected out-of-pocket health care costs, above benefits received from Medicare, will be comparable to their total retirement savings, suggesting a critical need to encourage greater savings for these future expenses. Moreover, there is increasing concern that the Medicare program itself will not keep pace with cost and demographic trends, forcing employees to rely even more heavily on other sources of health care financing. Historically, many employers have provided health care benefits for their active employees, and some have extended these programs to include retirees. However, competitive pressures, FASB/GASB accounting requirements and other financial considerations are making it increasingly difficult for employers to maintain traditional retirement health benefit programs. As a result, employers have desired to find ways of providing retirement health care assistance for their employees without the prohibitive financial costs or risks associated with defined benefit health plans.

### BRIEF SUMMARY OF THE INVENTION

Embodiments of the invention provide a health account retirement plan (“HARP”) that can be used by a retiree for health care related expenses. Under the HARP, the employer pays an annual premium to an insurance company such as a health insurance company (“insurer”). In exchange, the insurer funds and administers health accounts for eligible employees at retirement. Employees become eligible for these benefits according to a pre-determined eligibility schedule comparable to a vesting schedule for pension benefit. Once eligible, if an employee retires, he can use the account for health care related expenses including both premiums and health claims.

Advantageously, the HARP is a fully insured solution, so that the employer transfers to the insurer all risk associated with funding and administering the plan. The employer can terminate the HARP at the end of any year and all accrued benefits for retirees and eligible active employees will be maintained and administered by the insurer. All management and administration of the HARP can be performed by the insurer rather than the employer.

Additional advantages of the HARP are its favorable treatment with respect to governmental regulatory provisions. For example, as a fully insured benefit plan, the HARP is less likely to raise discrimination issues often associated benefits provider to longer-service employees. Premiums for the HARP plan are deductible by the employer for tax purposes as paid, and the insured benefits under the HARP should be afforded favorable treatment under FASB and GASB. The HARP design also avoids the need for an employer to establish and maintain a VEBA or similar trust arrangement to fund retiree obligations, and does not generate unrelated business income subject to taxation for for-profit employers.

As a further advantage, the HARP benefits can be linked with a network of health care providers (e.g., under contract with the insurer) to allow retirees access to discounted rates for health care services paid from the account. They may also be offered a variety of coverage options to meet their specific needs at time of retirement.

In one aspect, a method is provided for providing a first employee of an employer with a health care account, the health care account funded and administered in exchange for periodic premium payments made by the employer and comprising funds for paying health care related claims made by the employee during the employee's retirement, the method comprising crediting the health care account for one period in a fixed amount according to a contractual schedule established with the employer, and calculating an incremental premium to charge the employer for the one period in exchange for funding and administering the account corresponding to the employee.

In another aspect, a method is provided for receiving health care benefits from a health care account funded and administered by a insurer in exchange for periodic premium payments made by a former employer according to a contractual arrangement between the employer and the insurer, the method comprising, working as an employee of the employer for a required number of periodic intervals, satisfying an age threshold, and becoming vested in the health care account when the required number of intervals have been worked and the age threshold has been satisfied, wherein the required number of periodic intervals and age threshold are established via a contract between the employer and the insurer.

In yet another aspect, a method is provided for providing a first employee with a health care account funded and administered by a insurer, the health care account providing health care benefits to the employee during the employee's retirement, the method comprising providing demographic information to the insurer, and receiving a determined periodic premium charge from the insurer in exchange for funding and administering the health care account.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a diagram of a general environment in which a health account retirement plan operates, in accordance with an embodiment of the invention;

FIG. 2 is a chart of an exemplary benefit crediting schedule for a health account retirement plan, in accordance with an embodiment of the invention;

FIG. 3 is a flow diagram of a technique for maintaining a health account retirement plan, in accordance with an embodiment of the invention;

FIG. 4 is a flow diagram of a technique for calculating a premium associated with a health account retirement plan, in accordance with an embodiment of the invention;

FIG. 5 is flow diagram of a technique for earning and receiving benefits under a health account retirement plan, in accordance with an embodiment of the invention;

FIG. 6 is an exemplary table of computed eligibility discount factors for a class of employees, in accordance with an embodiment of the invention; and

FIG. 7 is an exemplary table for use in calculating eligibility discount factors, in accordance with an embodiment of the invention.

### DETAILED DESCRIPTION OF THE INVENTION

The following examples further illustrate the invention but, of course, should not be construed as in any way limiting its scope.

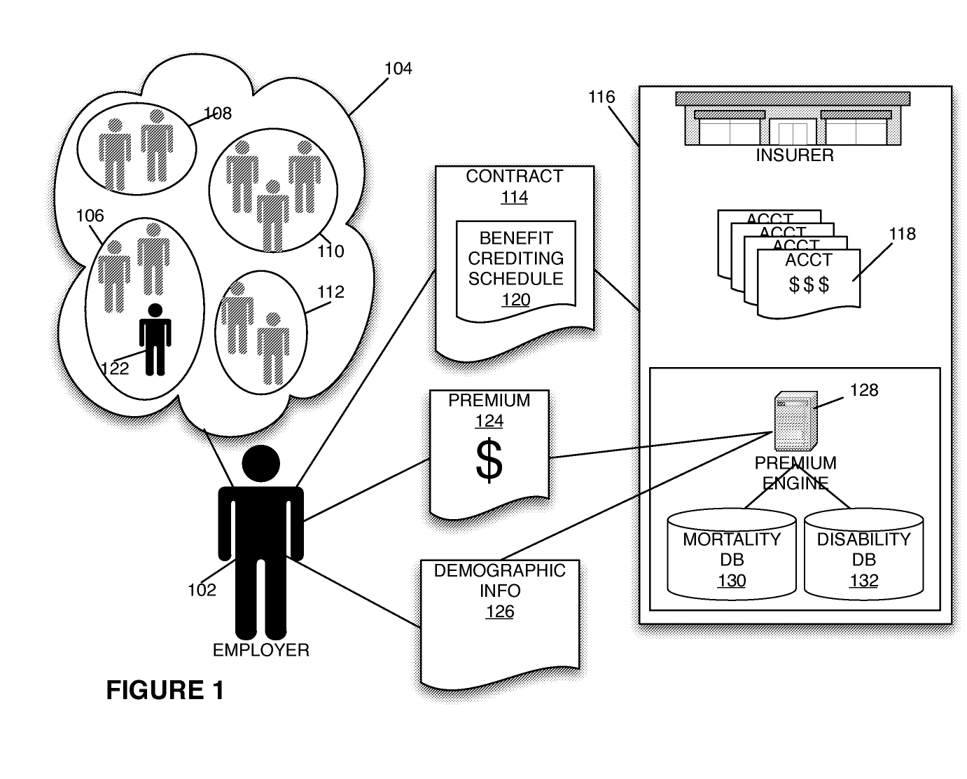

Turning to FIG. 1, an implementation of a system contemplated by an embodiment of the invention is shown with reference to an overall healthcare environment. An employer 102 has employed employees 104, generally ranging across age and gender, to conduct the business of the employer 102. Additionally, for accounting and other purposes, the employees 104 may be categorized by the employer 102 into any number of discrete groups. For example, if the employer 102 is a retailer selling products to consumers, one possible categorization comprises four categories: salaried employees in retail positions 106 (e.g., a store assistant manager), salaried employees in non-retail positions 108 (e.g., a marketer working at the corporate office); hourly employees in retail positions 110 (e.g., a store clerk), and hourly employees in non-retail positions 112 (e.g., a mailroom worker).

In order to provide an employment benefit to its employees, the employer 102 preferably enters a contractual relationship 114 with a health insurer (“insurer”) 116. Under the contract 114, the insurer preferably agrees to fund and administer a health account retirement plan (“HARP”) for eligible employees 104 of the employer 102. The insurer 116 may or may not provide other benefits, such as a traditional health care plan, for the employer 102 and its employees 104. Under the HARP, the insurer 116 maintains accounts 118 for those employees 104 who are or may become eligible. Eligibility requirements may be set according to the contract 114. One example of an eligibility requirement is an age threshold, such as a requirement that an employee is at least 35 years of age. The insurer 116 credits each account on a periodic basis (e.g., annually) in an amount according to a contracted benefit crediting schedule 120.

Benefits are not available to the employees 104 under the HARP until they meet all eligibility requirements (referred to hereinafter for simplicity as “vesting”) and retire. The insurer 116 and the employer 102 can agree on particular vesting requirements as terms of their contract 114. In some embodiments, the vesting requirements may be modified during the life of the HARP. One example of a vesting requirement is that an employee 122 meet a combination of age and service requirements, such as “age 55 with 10 years of continuous service”. Multiple combinations of vesting requirements may be used in an embodiment, such that an employee 122 becomes vested in her account 118 if she, for example reaches “age 55 with 10 years of continuous service OR reaches age 50 with 25 years of continuous service.” Any variation of combinations and other vesting requirements are also contemplated by embodiments of the invention. Additionally, exceptions can be made in the vesting requirements for cases of an employee dying or becoming disabled.

Once an employee 122 is vested in her HARP account 118, the funds in the account become available to the employee 122 when the employee ceases to be employed by the employer 102, usually, though not exclusively, by retirement. The funds in the account 118 can be used for any purpose allowed by applicable governmental regulations (particularly the requirements of Section 213(d) of the Internal Revenue Code), including, but not necessarily limited to, health related expenses for the welfare of the now former employee 122 and/or her dependents. Alternatively, the employer may define a more limited universe of uses within applicable governmental regulations, e.g, excluding certain types of health services or insurance benefits from payment by the plan. The former employee 122 can submit claims for reimbursement of these expenses to the insurer 116. Alternatively, or in addition, the former employee 122 may be provided one or more options to facilitate the use of funds in the account 118. Such options can include a checkbook or debit card that draws on the account 118. Furthermore, in one embodiment, health care providers and pharmacies participating in the insurer's 116 network can submit claims directly to the insurer 116 for reimbursement, sparing the former employee 122 from the need to submit claims. Additionally, in one embodiment the insurer 116 can offer the former employee 122 negotiated pricing for those health care providers in the insurer 116 network, so that the former employee 122 is charged reduced, contracted costs for services purchased from those providers.

As an additional feature of the HARP, some embodiments offer the former employee 122 the opportunity to purchase a predetermined plan of benefits. The price for such a plan can be determined periodically (e.g., annually). The former employee 122 would have the option of declining the plan, or electing the plan and having a corresponding amount deducted from her HARP account 118. Such a plan can be offered on a guaranteed basis (i.e., without underwriting) or subject to some level of underwriting at time of retirement. In some embodiments, different base plans are offered depending on whether or not the former employee 122 is eligible for other benefits, such as Medicare. Some embodiments also include “buy-up” options in addition to a base plan, for example adding coverage for dental care or prescription drugs or purchasing more comprehensive benefits subject to underwriting. The base and buy-up plans can be subject to change periodically by the insurer 116. The plans can also include a cost and benefit adjustment or buy-up for state-mandated benefits based on the former employee's 122 state of residence.

In exchange for funding and administering the HARP for its employees 104, the employer 102 pays the insurer 116 a periodic (e.g., annual) premium 124. The premium 124 is fixed for the period (e.g., a year) and preferably adjusted prospectively for each subsequent period. The premium 124 is calculated for each class 106, 108, 110, 112 of eligible employees based on demographic information 126 for the employees within the class. Exemplary demographic information 126 includes age, gender, length of service, and annual turnover information. This demographic information 126, in addition to a vesting schedule (not shown) and benefit crediting schedule 120 are used as inputs for a premium engine 128 of the insurer 116. The premium engine 128 uses the inputs and additional information, such as mortality rate information 130 and disability rate information 132, to calculate the periodic premium 124 to charge the employer 102. The employer 102 is preferably charged a single premium 124 which aggregates all individual employee 104 premiums corresponding to HARP accounts 118 maintained by the insurer 116. In some embodiments, the disability rate information 132, mortality information 130, and retirement rate information are obtained from actual employer experience information and/or projections of future employer experience., industry data, or insurer information (e.g., claim history data), as reflected in tables such as 94GAM or tables published by the Society of Actuaries.

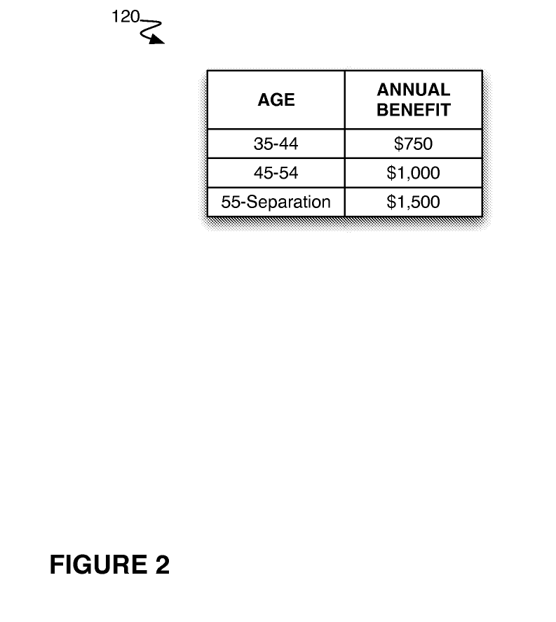

Turning to FIG. 2, a exemplary benefit crediting schedule 120 is shown. The rates of benefit crediting in the example are based solely on the age of the employee. Each year, employees between the ages of 35 and 44 (as of a designated annual date, such as January 1) receive a credit of $750 into their HARP accounts. Employees between the ages of 45 and 54 receive $1,000. Employees over 55 receive $1,500. Employees under 35 are not yet eligible for a HARP account credit. Countless variations of the crediting schedule 120 are possible, and contemplated by embodiments of the invention.

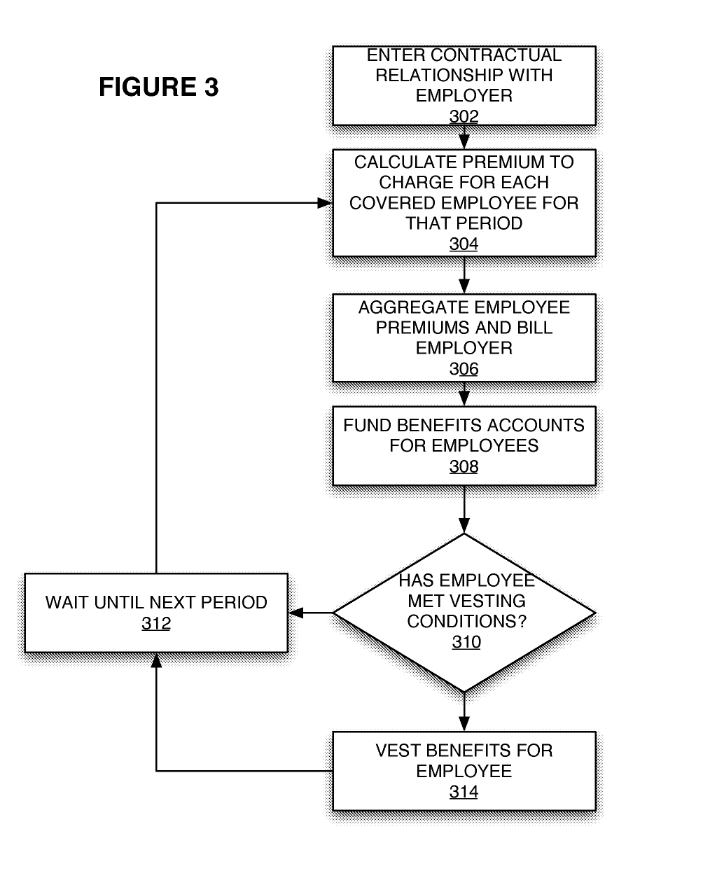

With respect to FIG. 3, a technique is shown whereby an insurer or other suitable organization provides HARP accounts for employees of an employer, in accordance with an embodiment of the invention. At step 302, the insurer enters a contractual relationship with the employer to provide a HARP plan. As previously discussed, the details of the contract can be customized to allow for variability of benefit crediting schedules, eligibility requirements, vesting schedules, etc. For each covered employee, the insurer calculates at step 304 a premium to charge the employer in exchange for funding and administering the employee's HARP account that period, as well as for assuming risk associated therein. All the employee premiums are aggregated at step 306 and the employer is billed the aggregate amount. At step 308, the insurer credits the HARP accounts for the covered employees according to the benefit crediting schedule. At step 310, it is determined whether an employee has met the vesting conditions associated with the employer's HARP plan. If the vesting criteria are not satisfied, then, after working for the employer another time period at step 312, the process repeats the following period at step 304. If the vesting criteria are satisfied, the benefits for the employee become “vested”, such that the employee (or her legal representatives) will obtain access to her corresponding HARP account should she retire or otherwise separate from her employment (e.g., termination of employment, death, disability, etc.). Should she continue to work for the employer another time period at step 312, then she can receive additional benefit credits to her HARP account by repeating the process at step 304.

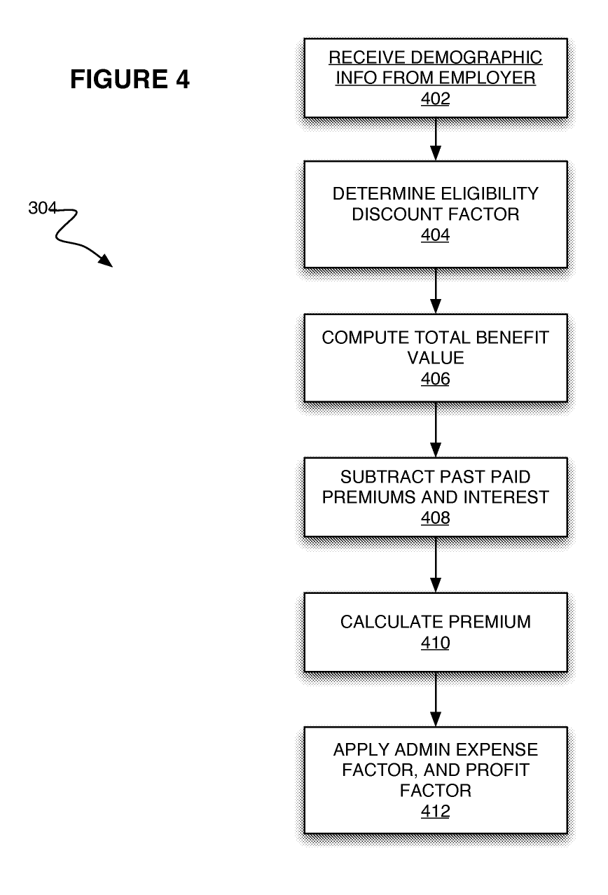

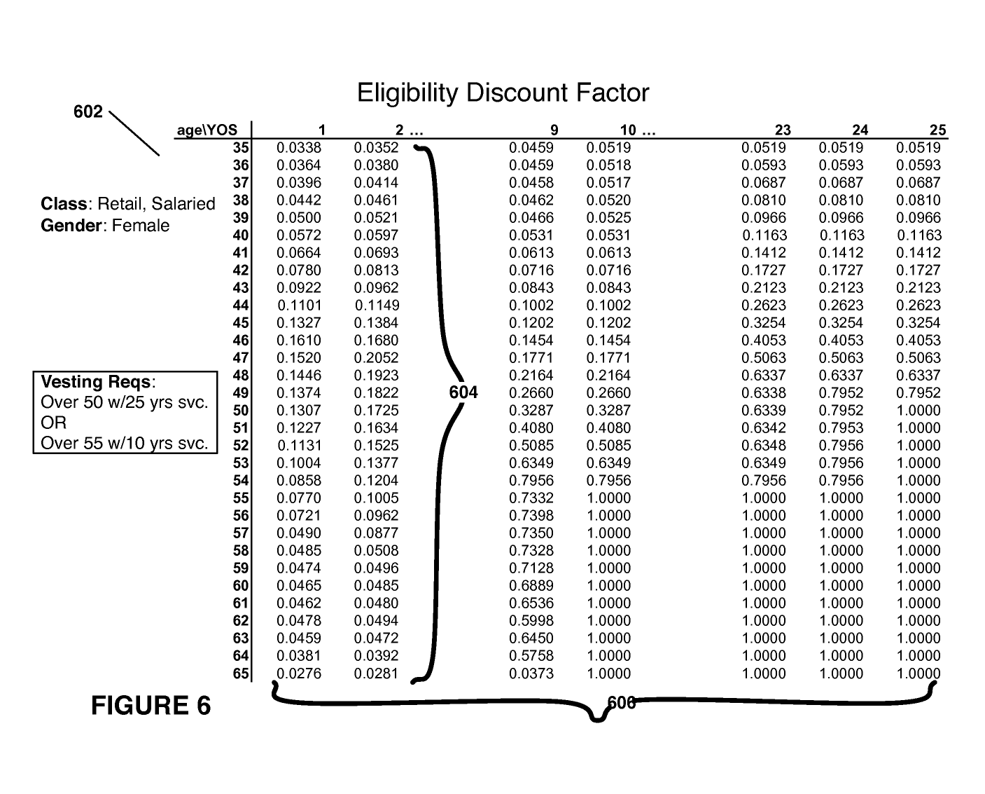

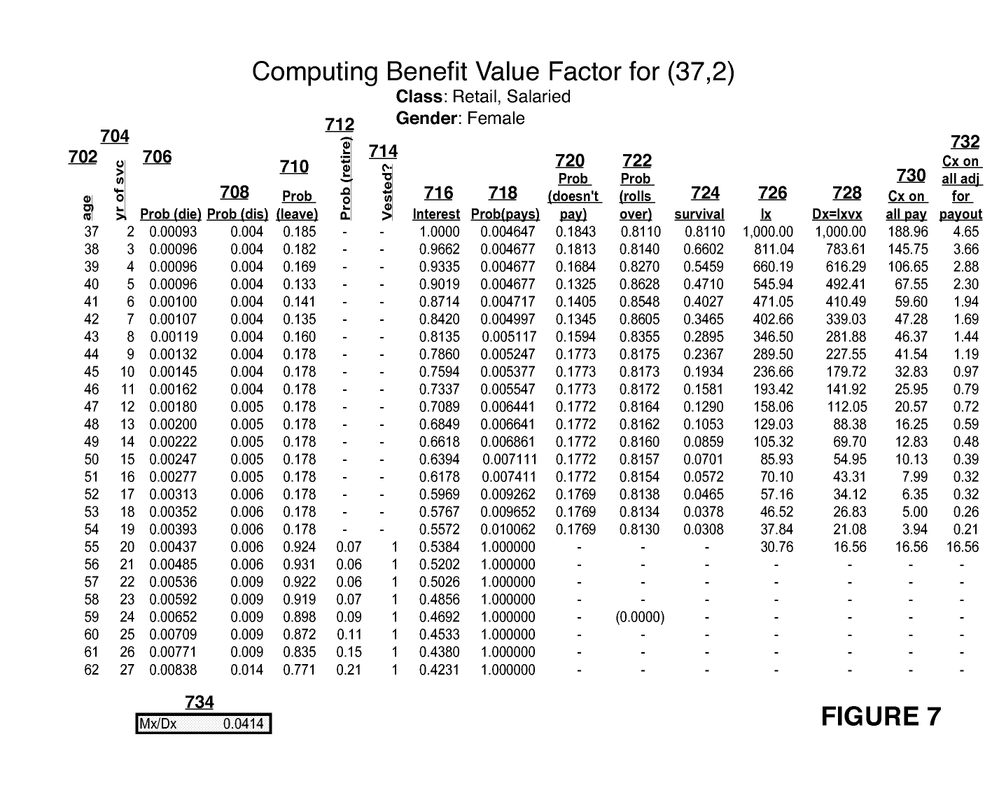

The premium calculation process 304, as performed in an embodiment of the invention, is shown in more detail in FIG. 4. Such a premium calculation is preferably performed by a premium engine at the insurer. At step 402, the insurer receives demographic information from the employer for each covered employee. Such demographic information can include, for example, the employee's age and gender, employment class. Using this demographic information, along with a mortality risk adjustment (i.e., due to death, the employee would not reach retirement age or would leaves some portion of the account unused), a disability adjustment (reflecting the possibility the employee would vest early due to disability), and expected turnover due to retirement or employment termination within the employee's employment class, an eligibility discount factor is determined for the employee at step 404. The eligibility discount factor is an expected probability between 0.0 and 1.0 (inclusive) that reflects the likelihood that an employee will remain employed sufficiently long that her benefits would vest and that she will ultimately receive a benefit under the plan. For example, a newly-hired young employee in an employee class with relatively rapid turnover would have a small eligibility discount factor (e.g., 0.04), while a long-service employee who has reached or is near reaching her vesting requirement would have an eligibility discount factor near 1.0. Additional details in computing the eligibility discount factor are described herein with respect to FIGS. 6 and 7.

Once the eligibility discount factor has been determined, a total benefit value for the employee is computed at step 406 by multiplying the eligibility discount factor by the employee's total accrued benefit in her corresponding HARP account (including the incremental amount credited for the current period). In some embodiments, a nominal rate of interest may be credited to balance in the employee's health account; if so this interest is included in the determination of the employee's accrued benefit. In other embodiments, no interest is credited to the balance in the employee's account. In the same manner, a total benefit value for all other employees under the HARP, and these values are aggregated to determine a cumulative total benefit value (i.e., total claim liability) under the plan. Premiums paid by the employer under the HARP for prior time periods, along with interest credited to those prior period premiums, are subtracted from the total benefit value at step 408 to determine the incremental claim liability for the current period. This incremental claim liability forms the basis of determining the premium to be charged to the employer in the current period at step 410. The actual premium is preferably adjusted at step 412 by applying an applicable present value discount, an administrative expense factor, and a profit factor. Alternatively, the present value discount is applied during the determination of the eligibility discount factor at step 404. The present value discount reflects the likely amount of time until benefits are paid out of the account. The administrative expense factor covers both the current time period and the future costs of administering the employee's HARP account during retirement.

The premiums preferably remain fixed during the time period, subject to adjustment only for changes in the underlying census, e.g., new employee additions, corrections to the census data, etc. The premiums are further preferably designed such that the employer can terminate the contract at the end of any plan period and the insurer would retain full responsibility for funding and administering the benefits for all then-current retirees, as well as any active employees who had satisfied the vesting criteria as of the date the contract was terminated.

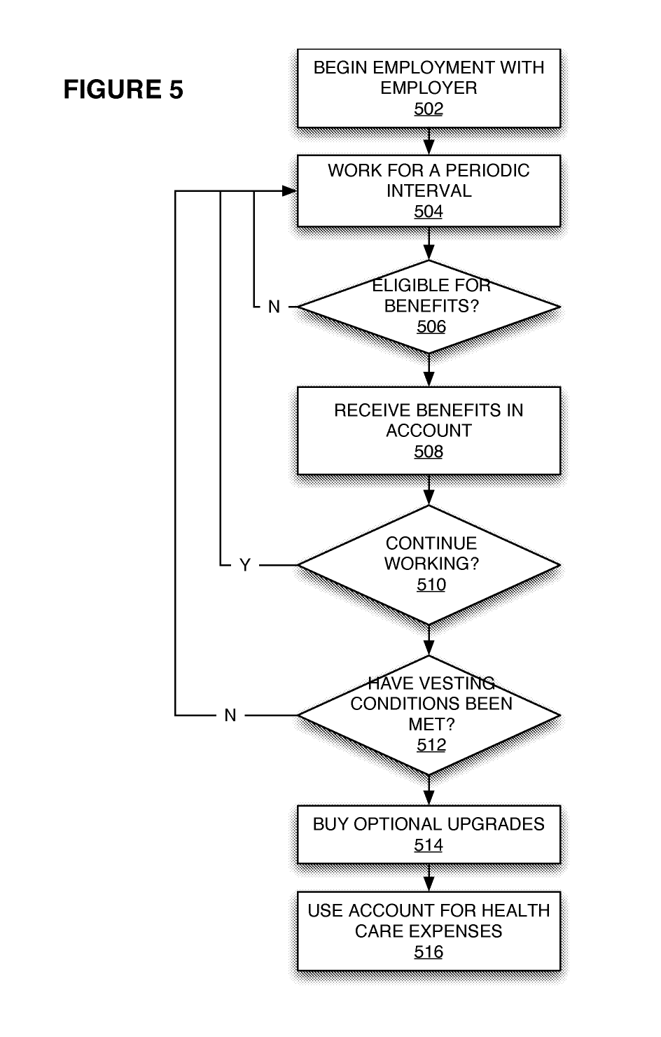

Turning to FIG. 5, the operation of an exemplary HARP account is described from the perspective of an employee. The employee begins employment with the employer at step 502 and works for a periodic interval at step 504. At step 506, it is determined if the employee is potentially eligible for a benefit under the HARP plan. If so, she accrues benefits in her HARP account at step 508. Steps 504, 506 and 508 repeat for each consecutive time period until, at step 510, the employee stops working for the employer. At that time, it is determined at step 512 whether or not the vesting conditions have been met by the employee. If not, then she is not eligible to receive any benefit under the HARP. If so, then she may be given the opportunity to purchase optional “upgrade” benefits for her account at step 514, and she can have full use of her HARP account to pay for health care related expenses at step 516.

In still greater detail, the calculation of the eligibility discount factor, as used in embodiments of the invention for computing premiums, is described with reference to FIG. 6. For each combination of employment class and gender, a chart 602 is preferably generated to display eligibility discount factors. For example, chart 602 displays the eligibility discount factors for females in the “retail, salaried” class. To lookup the eligibility discount factor for a given employee in the gender/class combination corresponding to the chart, the appropriate “age” row 604 and “years of service” column 606 is referenced. A factor of 1.0 indicates benefits have vested for an employee, while factors near 0.0 indicate a low likelihood that the employee's benefits will vest.

To compute each eligibility discount factor entry in the chart 602, a series of calculations is performed as shown in FIG. 7. The entire chart of FIG. 7 is used to compute the sole value displayed in row 35, column 1 of the chart in FIG. 6, that is the eligibility discount factor for a female, salaried, retail employee of age 37 with two years of service. The age column 702 has a first row entry corresponding to the age of the employee and projects 25 additional years. The years of service column 704 acts similarly. Column 706 is a mortality rate for the age in column 702 obtained, for example, from 94GAM data. Column 708 is a morbidity (disability incidence) rate for the age in column 702, without any recovery assumption. Column 710 is a work termination rate, or probability of leaving employment for reasons other than death, disability or retirement, for someone with the years of service in column 704 and in the given employment class. Column 712 is the rate of retirement for someone of the age in column 702, for example, obtained from SOA tables. Column 714 is an indicator of whether a person of age in column 702 and with years of service in column 704 has vested benefits under the HARP plan.

Column 716 is an interest discount factor. Column 718 is the probability that benefits will pay out during that year, i.e., the probability of death or disability plus, if vested, the probability of termination or retirement. Column 720 is the probability that the benefits will terminate unvested, i.e., the probability that the employee survives without disability but terminates employment or retires prior to vesting. Column 722 is a probability that benefits roll from one year to the next, i.e., not column 718 and not column 720. Column 724 is a cumulative probability corresponding to column 722, i.e., the probability that benefits will rollover from the first row year to the current row year.

Column 726 is the expected number of employees remaining assuming 1,000 start in the first row year. Column 728 is a discount of this expected number with interest. Column 730 is expected payout for those employees not surviving column 726, discounted with interest. Column 732 is the expected payout for those employees not surviving column 726, less those unvested, discounted with interest. Cell 734 receives the sum of column 732 is divided by 1,000, i.e., the sum over time of the pattern of payout discounted in each year for interest and survival. This value can be displayed in the appropriate cell in the chart of FIG. 6.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for providing a first employee of an employer with a health care account, the health care account funded and administered in exchange for periodic premium payments made by the employer and comprising funds for paying health care related claims made by the employee during the employee's retirement, the method comprising:
crediting the health care account for one period in a fixed amount according to a contractual schedule established with the employer; and
calculating an incremental premium to charge the employer for the one period in exchange for crediting and administering the account corresponding to the employee.

2. The method of claim 1 wherein calculating the incremental premium comprises:
receiving demographic information from the employer;
determining an eligibility discount factor corresponding to the employee based on at least the demographic information;
maintaining an accrued benefit balance for the account corresponding to the employee; and
computing a total benefit value corresponding to the employee based on at least the eligibility discount factor and the accrued benefit balance.

3. The method of claim 2 wherein the employee is a member of an employment class, and wherein the demographic information comprises:
the employee's age; and
the employee's gender.

4. The method of claim 2 wherein determining the eligibility discount factor is further based on:
a mortality risk corresponding to the employee; and
a disability risk corresponding to the employee; and
an expected employment turnover corresponding to the employment class.

5. The method of claim 2 further comprising:
vesting the accrued benefit balance if the employee satisfies one or more vesting criteria.

6. The method of claim 5 wherein the vesting criteria comprise a combination of at least:
an age criterion; and
an employment longevity criterion.

7. The method of claim 1 further comprising adjusting the incremental premium through application of:
a present value discount; and
an administrative expense factor.

8. The method of claim 1 further comprising adjusting the incremental premium through application of:
a profit factor.

9. The method of claim 1 further comprising:
calculating incremental premiums corresponding to a plurality of employees of the employer for the one period; and
aggregating the incremental premium corresponding to the first employee with the incremental premiums corresponding to the plurality of employees to establish a single incremental premium to be paid by the employer for the one period.

10. A method of receiving health care benefits from a health care account funded and administered by an insurer in exchange for periodic premium payments made by a former employer according to a contractual arrangement between the employer and the insurer, the method comprising:
working as an employee of the employer for a required number of periodic intervals;
satisfying an age threshold; and
becoming vested in the health care account when the required number of intervals have been worked and the age threshold has been satisfied;
wherein the required number of periodic intervals and age threshold are established via a contract between the employer and the insurer.

11. The method of claim 10 further comprising:
accruing funds in the health care account for each of the periodic intervals, the funds being credited in the periodic interval by the insurer.

12. The method of claim 11 wherein the funds in the health care account are available for use when no longer working as an employee of the employer.

13. The method of claim 11 wherein the amount of funds credited in each of the periodic intervals is determined according to a schedule of the contract.

14. The method of claim 13 wherein the amount of funds credited in the periodic intervals at least occasionally increases with the age of the employee.

15. The method of claim 14 wherein the periodic intervals are further required to be continuous.

16. The method of claim 10 wherein the required number of periodic intervals equals 10 years, and wherein the age threshold is 55 years.

17. The method of claim 10 further comprising:
electing to receive additional benefits from the insurer; and
reducing, by the insurer, an amount of funds from the health care account corresponding to the value of the elected benefits.

18. A method of providing a first employee with a health care account funded and administered by an insurer, the health care account providing health care benefits to the employee during the employee's retirement, the method comprising:
providing demographic information to the insurer; and
receiving a determined periodic premium charge from the insurer in exchange for funding and administering the health care account.

19. The method of claim 18 wherein the periodic premium charge is further in exchange for funding and administering an aggregation of health care accounts for a plurality of employees, the aggregation including the health care account corresponding to the first employee.

20. The method of claim 19 further comprising:
defining one or more employment classes for categorizing a plurality of employees;
and wherein the first employee is a member of one of the employment classes, and wherein the demographic information comprises:
the employee's age;
the employee's gender; and
an expected employment turnover corresponding to the employment class.
